(19) United States
(12) Patent Application Publication
(10) Pub. No.: US 2010/0315022 A1
(43) Pub. Date: Dec. 16, 2010

(54) Handheld Illuminating Torch

(75) Inventor: Martin Schnitzer, San Francisco, CA (US)

Correspondence Address: Nixon Peabody LLP, P.O. Box 60610, Palo Alto, CA, 94306, US

(73) Assignee: 2009 SENIOR GAMES LOCAL ORGANIZING COMMITTEE, Palo Alto, CA (US)

(21) Appl. No.: 12/485,867

(22) Filed: Jun. 16, 2009

(51) Int. Cl. H05B 41/36; F21L 4/00

(52) U.S. Cl. 315/307; 362/157; 362/183

(57) ABSTRACT

A handheld torch which comprises a cylindrical body that has a top and a bottom. The body is configured to be grasped by a person and is preferably made of wood. The torch includes a window portion configured to extend at least partially around the body and one or more light sources positioned within the window portion. The torch includes a power source that is coupled to the light source, where the power source located within the body. The torch includes circuitry within the body, in which the circuitry is coupled to the power source and the light source. The light source produces light which illuminates through the window portion when the light source is energized.

### TECHNICAL FIELD

The present disclosure relates generally to a hand held illuminating torch.

### BACKGROUND

Competitive games, such as the Olympic Games, have commonly employed a torch which is carried among persons prior to the opening ceremony. In particular, the World Olympic Games has typically used a gas powered torch which produces a flame. Although such torches are grand in design and symbolism, such devices are expensive and can potentially cause injury to those handling them.

What is needed is an inexpensive handheld torch which emits light and simulates a traditional torch.

### Overview

In an embodiment, a handheld torch which comprises a cylindrical body that has a top and a bottom. The body is configured to be grasped by a person and is preferably made of wood. The torch includes a window portion configured to extend at least partially around the body and one or more light sources positioned within the window portion. The torch includes a power source that is coupled to the light source, where the power source located within the body. The torch includes circuitry within the body, in which the circuitry is coupled to the power source and the light source. The light source produces light which illuminates through the window portion when the light source is energized.

In an embodiment, a handheld torch which comprises a cylindrical body that has a top surface and a bottom surface. The body preferably has a first diameter at the top surface and a second diameter at the bottom surface, wherein the first diameter is larger than the bottom diameter. The body preferably having a continuously varying outer diameter extending from the top surface to the bottom surface and is preferably made of wood. The torch includes a window portion that is configured to extend at least partially around the body and one or more light sources positioned within the window portion. The torch includes a power source that is coupled to the light source, wherein the power source is located within the body. The torch including circuitry within the body which is coupled to the power source and the light source, wherein the light source produces light which illuminates through the window portion when the light source is energized.

In one or more of the embodiments, a light reflecting element adjacent to the light source and positioned within a casing of the window portion. In one or more of the embodiments, the light source is a light emitting diode (LED). In one or more of the embodiments, the torch includes a motion sensing device that is coupled to the circuitry, the motion sensing device is configured to sense movement of the torch, wherein the circuitry is configured to vary the amount of light produced by the light source in response to movement of the torch. In one or more of the embodiments, the circuitry is configured to terminate power to the light source after the torch has not been sensed by the motion sensing device to move for a set amount of time. In one or more of the embodiments, the torch includes a solar cell positioned on the body which is coupled to the power source via the circuitry, wherein the current collected from the solar cell recharges the power source. In one or more of the embodiments, the window portion has a set height dimension and extends entirely around the outer surface of the body. In one or more of the embodiments, the window portion is made of a translucent material.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 illustrates a perspective view of the handheld torch in accordance with an embodiment.

FIG. 2 illustrates a block diagram of the handheld torch in accordance with an embodiment.

FIG. 3 illustrates a side view of the interior components of the casing of the window portion in accordance with an embodiment.

FIG. 4 illustrates a block diagram of the components of the torch in accordance with an embodiment.

### DESCRIPTION OF EXAMPLE EMBODIMENTS

Example embodiments are described herein in the context of a handheld torch. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used throughout the drawings and the following description to refer to the same or like items. It is understood that the phrase “an embodiment” encompasses more than one embodiment and is thus not limited to only one embodiment.

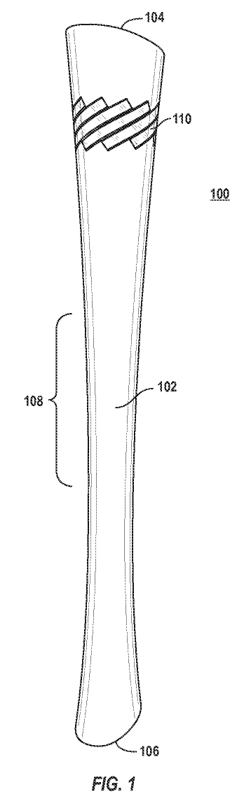

FIG. 1 illustrates a perspective view of the handheld torch in accordance with an embodiment. In particular, as shown in FIG. 1, the handheld torch 100 includes a body 102 which a user grasps to carry the torch 100. The body 102 is cylindrical and extends from a top 104 to a bottom 106. In an embodiment, the body 102 has a circular cross section as shown in FIG. 1, whereby the top 104 has a first diameter and the bottom 106 has a second diameter. It should be noted however that the body 102 may have any other cross sectional design (e.g. hexagonal, octagonal, square, and the like). It is preferred that the body 102 is made of wood or a composite thereof, although other materials such as plastic, metal and the like are contemplated.

In the embodiment in FIG. 1, the top 104 has a larger diameter than that of the bottom 106. However, it is contemplated in an embodiment that the diameter of the top 104 is smaller than the diameter of the bottom 106. In another embodiment, the diameters of the top 104 and bottom 106 are substantially similar.

In an embodiment, the body 102 has a configuration in which the diameter of the body 102 gradually decreases to minimum diameter area 108 from the top 104 and then gradually increases from the area 108 to the bottom 106. Thus, the body 102 preferably has a slight hourglass shape, although it is not necessary that the body 102 have such a shape configuration.

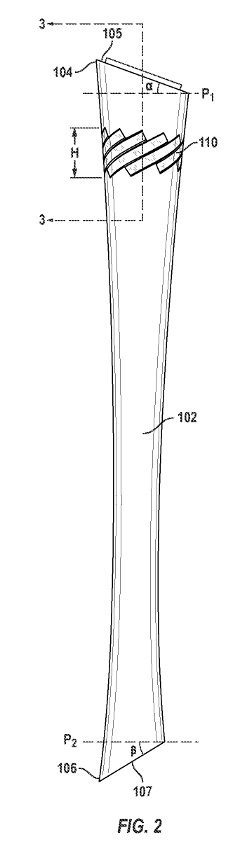

FIG. 2 illustrates a side view of the torch in accordance with an embodiment. As shown in FIG. 1, the top 104 of the body 102 has a top surface 105 and the bottom 106 has a bottom surface 107. Although not required, the torch 100 shown in FIG. 1 is configured such that the top surface 105 is at an angle a with respect to plane P1. Additionally or alternatively, the torch 100 shown in FIG. 1 is configured such that the bottom surface 107 is at an angle β with respect to a plane P2 which is substantially parallel to plane P1.

In addition, the torch 100 includes a window portion 110 located between the top 104 and bottom 106. In the embodiment in FIG. 1, the window portion 110 encircles the outer surface of the body 102 and has a height dimension H that is preferably smaller than the distance between the top 104 and bottom 106 of the body 102. Additionally or alternatively, the window portion 110 has a height dimension that extends substantially along the vertical length of the body 102 from the top 104 to the bottom 106.

In an embodiment, the window portion 110 encircles all the way around the outer surface body 102 at height dimension H. Alternatively, the window portion 110 extends only partially around the outer surface of the body 102. It should be noted that although only one window portion 110 is shown in FIG. 1, it is contemplated that more than one window portion 110 may be configured on the torch 100. It is further contemplated that in an embodiment where the torch 100 includes more than one window portion, the various window portions may have varying height dimensions and/or different circumferential lengths around the outer surface of the body 102.

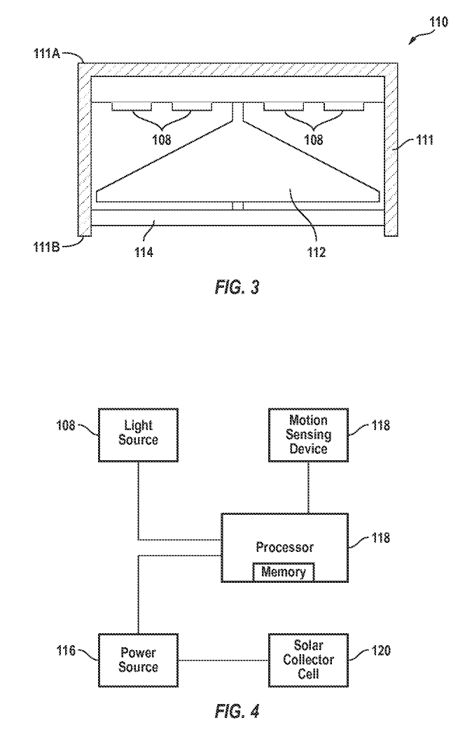

FIG. 3 illustrates a cross section of the window portion 110 along line 3-3 in accordance with an embodiment. The torch 100 preferably includes a housing 109 holding one or more light sources 10 within the body 102, whereby light produced from the one or more light sources, referred to as “light source” for brevity, illuminate through the window portion 110. It is preferred that the light source 108 is one or more light emitting diodes (LED) which illuminate the same or different colors.

In particular, the light source 108 is coupled to housing 109 which is preferably positioned within a casing 111 of the window portion 110. As shown in FIG. 3, four individual light sources 108 are shown coupled to the housing 109, however it is contemplated that any number of light sources 108 may be used, including only one light source. For brevity, “light source” is referred to in the specification to refer to the one or more light sources. The housing 109 is positioned near the top 111A of the casing 111 with the light source 108 oriented downward toward the bottom 111B of the casing 111. It should be noted that the housing 109 may alternately be positioned at the bottom 111B of the casing wherein the light source 108 is oriented upward toward the top 111A. It is preferred that the housing 109 is stationary and fixed within the casing 111, although it is contemplated that the housing 109, and thus the light source 108, be rotatable about a shaft, such as shaft 117 whereby a motor (not shown) causes the housing 108 to rotate about the shaft 117 while the light source 108 produces light. It should be noted that the illustrated housing 109 and light source 108 is only exemplary and other configurations of the light source 108 is contemplated for use with the torch 100. For instance, the torch 100 may be fully operational with the light source 108 without utilizing a housing 109.

As shown in FIG. 3, the casing 111 of the window portion 110 preferably includes a funnel shaped light reflector 112 housed within as well as a light base 114 positioned below the reflector 112. The light reflector 112 is preferably oriented such that the angled sides 113 of the reflector 112 face toward the light source 108 and the opening 115 of the reflector 112 faces the base. The reflector 112 preferably serves to reflect and dissipate the light emitted from the light source 118 outward toward the sides of the window portion 110 casing. In an embodiment, the window portion 110 is made of a clear, transparent glass or plastic, although the window portion 110 may alternatively be translucent or frosted. In an embodiment, the reflector 112 is made of plastic that is treated with a reflective coating to reflect and dissipate light. It is contemplated, however, that the reflector 112 may alternatively be made of a material having inherent reflective characteristics. Although not shown, it is preferred that a heat sink be coupled to the window portion to aid in dissipating heat produced from the light source 108 such that the internal components or body of the torch are not damaged.

FIG. 4 illustrates a block diagram of the internal components of the handheld torch in accordance with an embodiment. As shown in FIG. 2, the torch preferably includes the light source 108, a power source 116 coupled to the light source 108, and a processor 118 coupled to the light source 108 and the power source 116. The processor 118 preferably includes a memory which stores data. The power source 116 is preferably a rechargeable 14.4 volt battery which is located inside the body 102 and is removable therefrom.

It is preferred that the torch 100 includes a motion sensor 118, such as an accelerometer, which is coupled to the processor 118. It is preferred that the torch 100 includes a solar collector cell, although it is not necessary to include such a component, 120 coupled to the power source 116 and configured to recharge the power source 116. Although not shown in FIG. 4, it is contemplated that the solar collector cell 120 may be additionally configured to drive one or more of the other electronic components of the torch 100.

It is preferred that the processor 118 is programmable to configure the light source 108 to produce light in a desired manner. In an embodiment, the processor 120 may be programmed to vary the current and/or voltage supplied to the light source 108 to vary the light output in a predetermined manner. For example, the processor 120 may gradually and continuously vary the current supplied to the light source 108 in a continuous manner such that the light from the light source 108 gradually brightens and then dims in a continuous manner. In another example, the processor 120 may be configured to cause the light source 108 to randomly vary the brightness of the light output to simulate a flame being within the torch. In an embodiment in which the light source 108 is capable of outputting more than one color, the processor 120 may cause two or more colors to be output simultaneously or in sequential order. It should be noted that the torch 100 may employ a combination of two or more of the above.

In an embodiment, the processor 120 is coupled to the motion sensor 118, whereby the motion sensor 118 provides signals to the processor 120 when it senses motion of the torch 100. In response to receiving the sensor signals, the processor 120 varies the current to the light source 108. This causes the light source 108 to variably illuminate light out of the window portion 110 in direct response to the movement of the torch 100. As such, the light emitted from the light source 108 simulates an actual flame.

In an embodiment, the torch 100 has automatic shutdown capabilities to save power from the power source 116, although it is not necessary that the torch 100 have such capabilities. In particular, the processor 118 is configured to cut off or terminate power to the light source 108 upon the motion sensor 118 not providing any signals to the processor 118 for a set amount of time. The amount of time may be changed by the user whenever it is desired or may be fixed during manufacturing.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A handheld torch comprising:
a cylindrical body having a top and a bottom, the body configured to be grasped by a person;
a window portion configured to extend at least partially around the body;
a light source positioned within the window portion;
a power source coupled to the light source, the power source located within the body; and
circuitry within the body, the circuitry coupled to the power source and the light source, wherein the light source produces light which illuminates through the window portion when the light source is energized.

2. The torch of claim 1, further comprising a light reflecting element positioned within a casing of the window portion, the light reflecting element positioned adjacent to the light source.

3. The torch of claim 1, wherein the light source further comprises a plurality of light sources.

4. The torch of claim 1, wherein the light source is a light emitting diode (LED).

5. The torch of claim 1, further comprising a motion sensing device coupled to the circuitry, the motion sensing device configured to sense movement of the torch, wherein the circuitry is configured to vary the amount of light produced by the light source in response to movement of the torch.

6. The torch of claim 5, wherein the circuitry is configured to terminate power to the light source after the torch has not been sensed to move for a set amount of time.

7. The torch of claim 1, further comprising a solar cell positioned on the top of the body and coupled to the power source via the circuitry, wherein the current collected from the solar cell recharges the power source.

8. The torch of claim 1, wherein the body is made of a wood material.

9. The torch of claim 1, wherein the window portion having a set height dimension and extends entirely around the outer surface of the body.

10. The torch of claim 1, wherein the window portion is made of a translucent material.

11. A handheld torch comprising:
a cylindrical body having a top surface and a bottom surface, the body having a first diameter at the top surface and a second diameter at the bottom surface, wherein the first diameter is larger than the bottom diameter, the body having a continuously varying outer diameter extending from the top surface to the bottom surface;
a window portion configured to extend at least partially around the body;
a light source positioned within the window portion;
a power source coupled to the light source, the power source located within the body; and
circuitry within the body, the circuitry coupled to the power source and the light source, wherein the light source produces light which illuminates through the window portion when the light source is energized.

12. The torch of claim 11, further comprising a light reflecting element positioned within a casing of the window portion, the light reflecting element positioned adjacent to the light source.

13. The torch of claim 11, wherein the light source further comprises a plurality of light sources.

14. The torch of claim 11, wherein the light source is a light emitting diode (LED).

15. The torch of claim 11, further comprising a motion sensing device coupled to the circuitry, the motion sensing device configured to sense movement of the torch, wherein the circuitry is configured to vary the amount of light produced by the light source in response to movement of the torch.

16. The torch of claim 15, wherein the circuitry is configured to terminate power to the light source after the torch has not been sensed to move for a set amount of time.

17. The torch of claim 11, further comprising a solar cell positioned on the top of the body and coupled to the power source via the circuitry, wherein the current collected from the solar cell recharges the power source.

18. The torch of claim 11, wherein the body is made of a wood material.

19. The torch of claim 11, wherein the window portion having a set height dimension and extends entirely around the outer surface of the body.

20. The torch of claim 11, wherein the window portion is made of a translucent material.
